(19) United States
(12) Patent Application Publication
(10) Pub. No.: US 2026/0352004 A1
(43) Pub. Date: Nov. 5, 2026

(54) EASY-TO-ASSEMBLE ADAPTER AND CHARGING DEVICE

(71) Applicant: Shenzhen Deone Innovation Technology Co., Ltd, Shenzhen (CN)

(72) Inventors: HUAYONG XIE, Zhanjiang (CN); LEI YU, Shenzhen (CN); QIANG LIU, Jingzhou (CN)

(21) Appl. No.: 19/719,036

(22) Filed: Jun. 24, 2026

(30) Foreign Application Priority Data
Aug. 12, 2025 (CN) 202521709103.5

(51) Int. Cl. H02J 7/70; H01R 13/533; H01R 31/06

(52) U.S. Cl. CPC H02J 7/731; H01R 13/533; H01R 31/06

(57) ABSTRACT

The present disclosure provides an easy-to-assemble adapter and a charging device. The adapter includes a main body and a first connector. The first connector is connected to a first device. The main body is provided with a receiving slot for receiving the first device. The first connector is rotatably arranged in the receiving slot. The adapter further includes a rotating shaft limiting member detachably connected to the main body, the first connector is provided with a rotating shaft portion, and the main body and the rotating shaft limiting member clamp the rotating shaft portion jointly. The first connector is provided with the rotating shaft portion, and the rotating shaft limiting member and the main body clamp the rotating shaft portion jointly, such that the structure for rotatable arrangement of the first connector is simplified, miniaturization of the adapter is facilitated, and assembly of the first connector is also facilitated.

### CROSS-REFERENCE TO RELATED APPLICATIONS

This application claims priority to Chinese Patent Application No. 2025217091035, filed on Aug. 12, 2025, which is hereby incorporated by reference in its entirety.

### TECHNICAL FIELD

The present disclosure relates to the technical field of electronics accessories, in particular to an easy-to-assemble adapter and a charging device.

### BACKGROUND

Traditional adapters are connected to electronic devices by means of connecting cables, making it inconvenient to place the electronic devices. The new-generation adapters are provided with a receiving slot for receiving the electronic device, making it convenient for users to use the electronic device. A first connector is arranged in the receiving slot to avoid the use of one connecting cable.

Since the first connector of the previous adapters is arranged fixedly, the placement posture of the electronic device cannot be adjusted according to user requirements. In view of this, in subsequent adapters, the first connector is rotatably arranged in the receiving slot to meet the requirements of users for adjusting the placement posture of the electronic device.

Generally, the rotatably arranged first connector is assembled in a rotating module, and then, the rotating module is assembled into the adapter. Such an assembly method results in a complex structure of the adapter, which is not conducive to rotatable assembly of the first connector and the miniaturization of the adapter.

### SUMMARY

In view of the defects and deficiencies in the prior art, an objective of the present disclosure is to provide an easy-to-assemble adapter and a charging device. A first connector is provided with a rotating shaft portion, and a rotating shaft limiting member and a main body clamp the rotating shaft portion jointly, such that the structure for rotatable arrangement of the first connector is simplified, miniaturization of the adapter is facilitated, and assembly of the first connector is also facilitated.

To fulfill the above objective, the technical solution adopted by the present disclosure is as follows: an easy-to-assemble adapter includes a main body and a first connector, where the first connector is connected to a first device, the main body is provided with a receiving slot for receiving the first device, and the first connector is rotatably arranged in the receiving slot; and the adapter further includes a rotating shaft limiting member, the rotating shaft limiting member is detachably connected to the main body, the first connector is provided with a rotating shaft portion, and the main body and the rotating shaft limiting member clamp the rotating shaft portion jointly.

By adopting the above technical solution, the present disclosure has the following beneficial effects: the first connector is provided with the rotating shaft portion, and the rotating shaft limiting member and the main body clamp the rotating shaft portion jointly, such that the structure for rotatable arrangement of the first connector is simplified, miniaturization of the adapter is facilitated, and assembly of the first connector is also facilitated.

### BRIEF DESCRIPTION OF DRAWINGS

To more clearly explain the technical solutions in the embodiments of the present disclosure or the prior art, drawings used for describing the embodiments of the present disclosure or the prior art are briefly introduced below. Obviously, the drawings in the following description merely illustrate some embodiments of the present disclosure, and for those ordinarily skilled in the art, other drawings may be obtained on the basis of the following ones without creative labor.

FIG. 1 is a schematic structural diagram of an adapter according to an embodiment of the present disclosure.

FIG. 2 is an exploded view of the adapter according to an embodiment of the present disclosure.

FIG. 3 is a sectional view along A-A′ in FIG. 1.

FIG. 4 is a sectional view along A-A′ after a first connector in FIG. 1 is rotated.

FIG. 5 is a sectional view along B-B′ in FIG. 1.

FIG. 6 is a schematic structural diagram of a first shell according to an embodiment of the present disclosure.

FIG. 7 is a schematic structural diagram of a charging device according to an embodiment of the present disclosure.

FIG. 8 is an exploded view of the charging device according to an embodiment of the present disclosure.

FIG. 9 is a sectional view along C-C′ in FIG. 7.

FIG. 10 is a schematic structural diagram of a charging base.

FIG. 11 is a schematic structural diagram of a rotating shaft portion.

### REFERENCE SIGNS

100, adapter; 10, main body; 11, first shell; 111, receiving slot; 1111, front support surface; 1112, bottom support surface; 1113, rear support surface; 112, first heat-dissipation hole; 113, second heat-dissipation hole; 114, rotation limiting portion; 12, second shell; 121, partition; 122, assembly portion; 13, shaft hole; 20, first connector; 21, rotating shaft portion; 212, body; 213, rotating shaft; 22, plug; 23, first circuit board; 30, second connector; 31, second circuit board; 32, interface; 40, spacer; 50, sensed part; 60, rotating shaft limiting member; 70, receiving space; 71, circulation chamber; 72, receiving chamber; 200, charging base; 210, output module; 211, assembly slot; 214, output terminal; 220, sensor; 230, guide plate; 231, guide surface.

### DESCRIPTION OF EMBODIMENTS

The present disclosure is described in further detail below in conjunction with the accompanying drawings.

The following specific embodiment is merely used for explaining the present disclosure rather than limiting the present disclosure. After reading the specification, those skilled in the art may make non-creative modifications to this embodiment as needed, and all these non-creative modifications within the scope of the claims of the present disclosure are protected by the patent law.

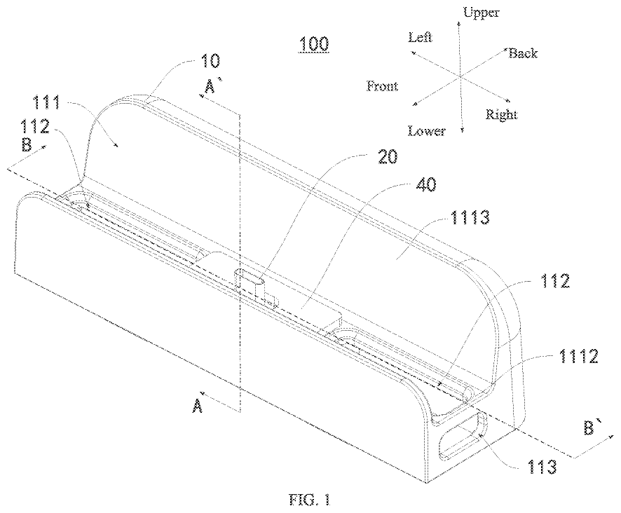

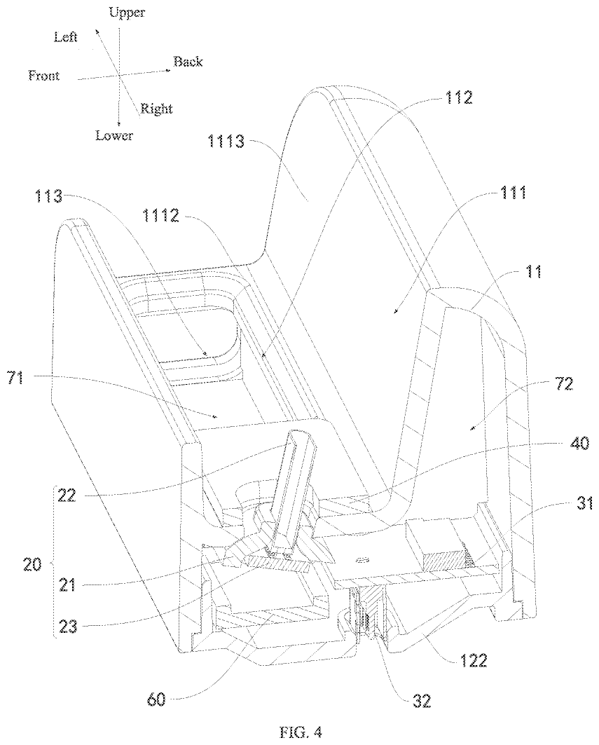

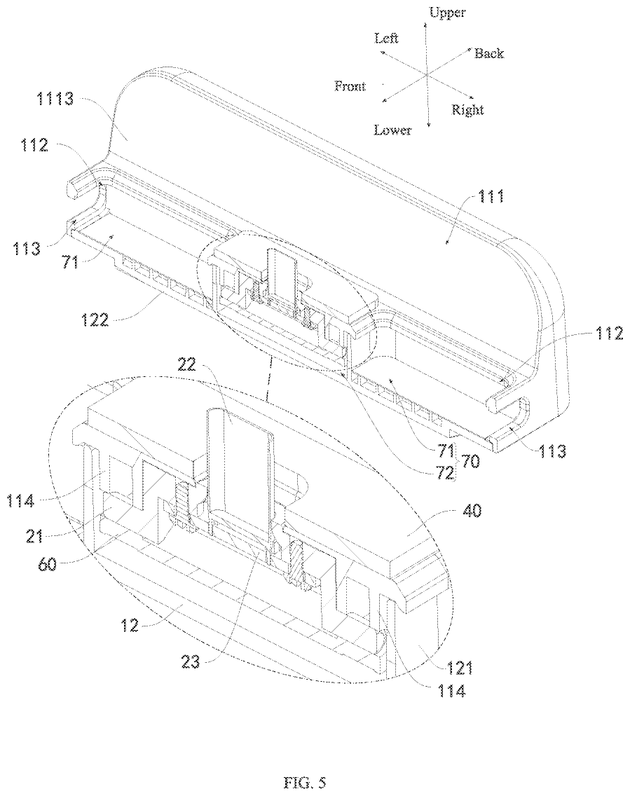

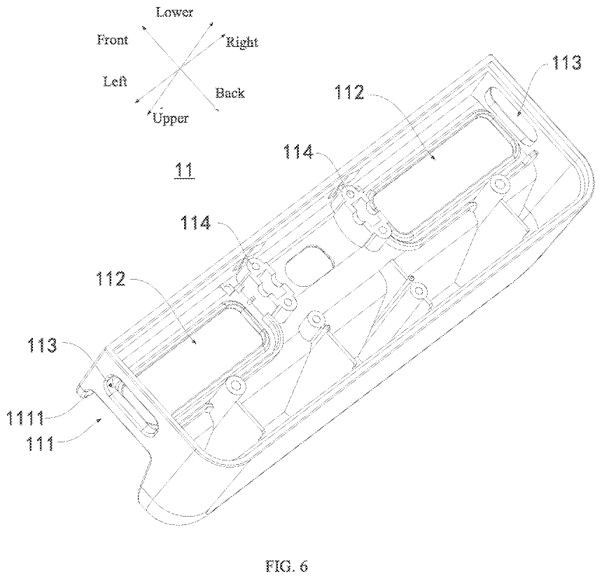

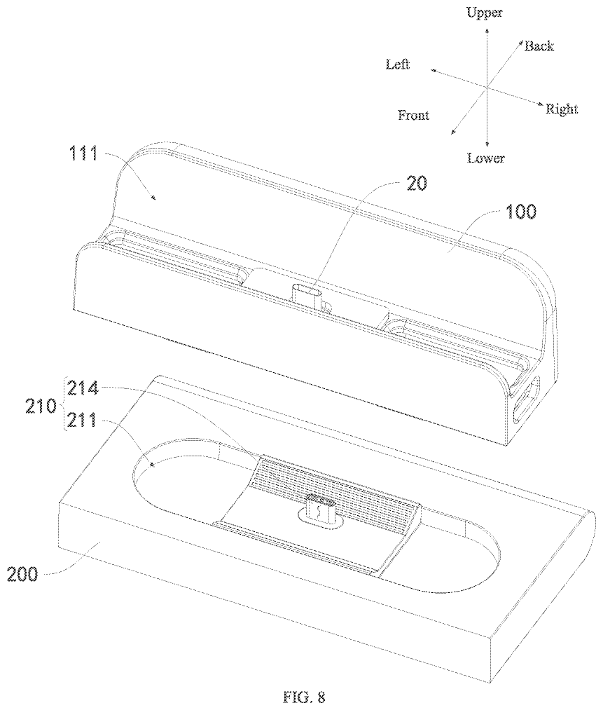

As shown in FIGS. 1-9, this embodiment relates to an easy-to-assemble adapter 100. The adapter 100 includes a main body 10, a first connector 20 and a second connector 30. The first connector 20 is connected to a first device, and the second connector 30 is connected to a second device. A receiving slot 111 for receiving the first device is formed in the main body 10, and the first connector 20 is rotatably arranged in the receiving slot 111.

The adapter 100 further includes a rotating shaft limiting member 60. The rotating shaft limiting member 60 is detachably connected to the main body 10. The first connector 20 is provided with a rotating shaft portion 21, and the main body 10 and the rotating shaft limiting member 60 clamp the rotating shaft portion 21 jointly. The first connector 20 is provided with the rotating shaft portion 21, and the rotating shaft limiting member 60 and the main body 10 clamp the rotating shaft portion 21 jointly, such that the structure for rotatable arrangement of the first connector 20 is simplified, miniaturization of the adapter 100 is facilitated, and assembly of the first connector 20 is also facilitated.

The first device is a device to be charged or a first information interaction device, and the second device is a power supply device or a second information interaction device. The first device and the second device are connected by means of the adapter 100 to implement charging of the first device or information interaction between the first device and the second device.

In this embodiment, the first connector 20 further includes a plug 22 and a first circuit board 23, and the plug 22 is electrically connected to the first circuit board 23. The rotating shaft portion 21 is provided with an avoidance hole, and the plug 22 extends through the avoidance hole, such that the first circuit board 23 and the plug 22 are assembled on the rotating shaft portion 21, and the plug 22 is exposed out of the receiving slot 111. The first circuit board 23 and the rotating shaft portion 21 are fixedly connected by means of screws.

In an implementation mode, the first circuit board 23 and the rotating shaft portion 21 are connected by one or a combination of several of snap-fit connection, bonding, ultrasonic welding and hot-melt connection.

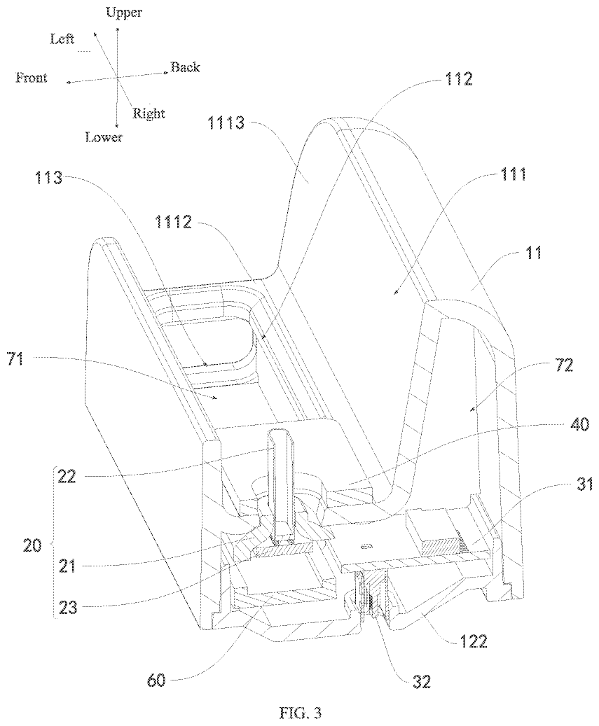

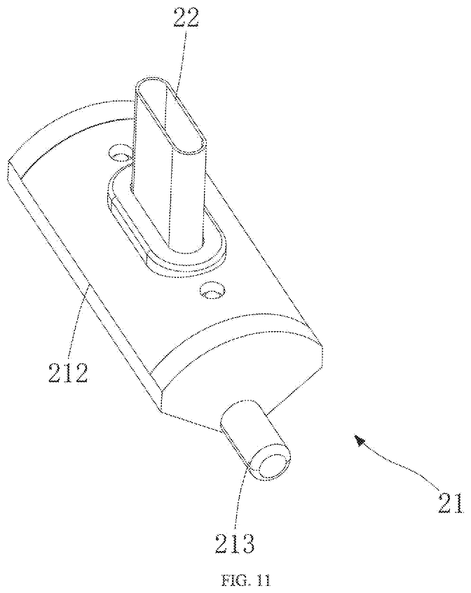

As shown in FIGS. 3, 4 and 11, the rotating shaft portion 21 includes a body 212 and rotating shafts 213 located on two sides of the body 212, and the circumferential section of the body 212 of the rotating shaft portion 21 is sector-shaped or arc-shaped. A chamfered surface fitting with an outer surface of the body 212 is arranged at a position, corresponding to the body 212 of the rotating shaft portion 21, inside the main body 10, where the chamfered surface is an arc surface. By means of such an arrangement, when the rotating shaft portion 21 rotates, the outer surface of the body 212 is limited by the chamfered surface, such that the entire rotating shaft portion 21 is more stable during rotation, and abrasion between the rotating shaft portion 21 and the main body 10 is reduced.

In this embodiment, the second connector 30 includes an interface 32 and a second circuit board 31, and the interface 32 is electrically connected to the second circuit board 31. The first circuit board 23 and the second circuit board 31 are electrically connected by means of a lead. The second circuit board 31 is fixedly connected to the main body 10 by means of screws.

In an implementation mode, the second circuit board 31 and the rotating shaft limiting member 60 are fixedly connected by one or a combination of several of bolted connection, snap-fit connection, bonding, ultrasonic welding and hot-melt connection.

In another implementation mode, the second circuit board 31 and the main body 10 are connected by one or a combination of several of snap-fit connection, bonding, ultrasonic welding and hot-melt connection.

In this embodiment, the rotating shaft limiting member 60 and the main body 10 are connected by means of screws. In an implementation mode, the rotating shaft limiting member 60 and the main body 10 are connected by one or a combination of several of snap-fit connection, bonding, ultrasonic welding and hot-melt connection.

As shown in FIGS. 1-9, the rotating shaft portion 21 extends in a length direction of the receiving slot 111. A direction from the first connector 20 to the rotating shaft limiting member 60 is perpendicular to the length direction of the receiving slot 111. In this way, the first connector 20 may rotate close to a front support surface 1111 of the receiving slot 111 or a rear support surface 1113 of the receiving slot 111 to adjust the placement posture of the first device (to be specific, to adjust the tilt angle of the first device when the first device is placed in the receiving slot 111).

In an implementation mode, the length direction of the receiving slot 111 is a left-right direction, a thickness direction of the adapter 100 is an up-down direction, and a width direction of the adapter 100 is a front-back direction.

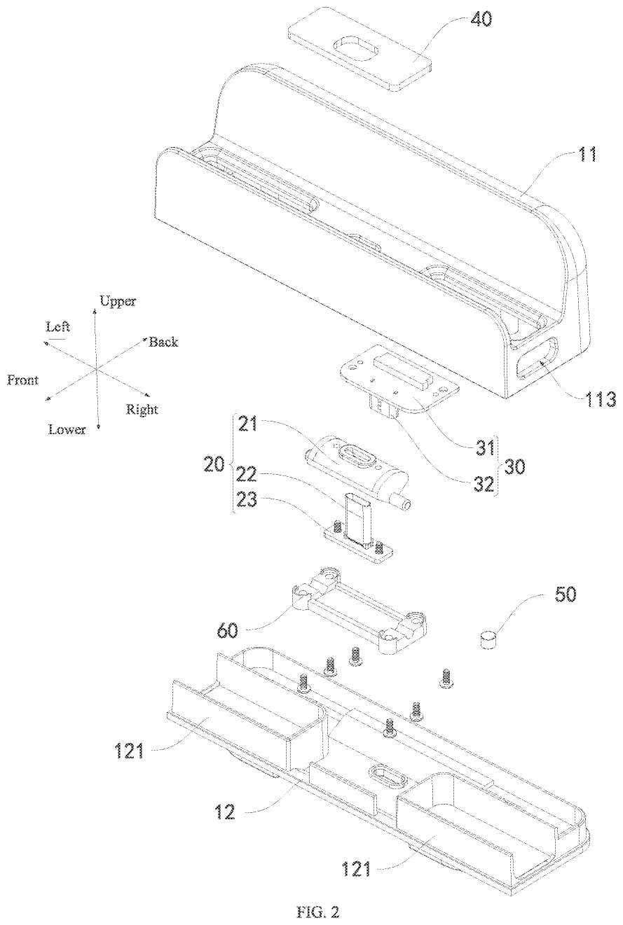

As shown in FIGS. 2-6, the main body 10 is provided with a rotation limiting portion 114 that extends towards the rotating shaft limiting member 60, the rotation limiting portion 114 and the rotating shaft limiting member 60 define a shaft hole 13 jointly, and the rotating shaft portion 21 is inlaid in the shaft hole 13, such that the rotating shaft portion 21 is clamped by the rotation limiting portion 114 and the rotating shaft limiting member 60 jointly, enabling the first connector 20 to be rotatably arranged in the receiving slot 111.

In a first embodiment, the rotation limiting portion 114 is provided with a first groove, and the rotating shaft limiting member 60 is provided with a second groove. The first groove and the second groove form the shaft hole 13 jointly.

In a second embodiment, the rotation limiting portion 114 is provided with a first groove, and the rotating shaft limiting member 60 covers an opening of the first groove. The first groove and the rotating shaft limiting member 60 form the shaft hole 13 jointly.

In a third embodiment, the rotating shaft limiting member 60 is provided with a second groove, and the rotation limiting portion 114 covers an opening of the second groove. The rotation limiting portion 114 and the second groove form the shaft hole 13 jointly.

In use of the first device, the first device may be easily damaged due to collision, so the first device is generally sleeved with a protective case. In a case where the first device sleeved with the protective case is placed in the receiving slot 111, the first connector 20 needs to be longer as compared with a case where the first device is not sleeved with the protective case, that is, the plug 22 needs to be longer to guarantee the connection between the first connector 20 and the first device. To adapt to the case where the first device is sleeved with the protective case and the case where the first device is not sleeved with the protective case, the first connector 20 generally has a greater length, so a gap will be formed between the first device and the receiving slot 111 in the case where the first device is not sleeved with the protective case, and as a result, the joint between the first connector 20 and the first device is easily damaged.

As shown in FIGS. 1-5, the adapter 100 further includes a spacer 40, and the spacer 40 is disposed around the first connector 20 to fill in the gap between the first device and the receiving slot 111, such that the first device contacts the receiving slot 111 by means of the spacer 40 in the case where the first device is not sleeved with the protective case, and a load originally at the joint between the first connector 20 and the first device is dispersed, thereby avoiding the situation where the joint between the first connector 20 and the first device is damaged due to the load.

In this embodiment, the spacer 40 is square and provided with a through-hole, and at least a portion of the first connector 20 extends through the through-hole to expose the first connector 20. To be specific, the plug 22 of the first connector 20 extends through the through-hole.

In an implementation mode, front and rear ends of the spacer 40 extend upward to fill in a gap between the first device and the front support surface 1111 of the receiving slot 111 and fill in a gap between the first device and the rear support surface 1113 of the receiving slot 111, so as to better protect the first device.

In another implementation mode, a plurality of spacers 40 are distributed on the periphery of the first connector 20 to fill in the gap between the first device and the receiving slot 111.

As shown in FIGS. 1-6, the receiving slot 111 includes the front support surface 1111, the rear support surface 1113 and a bottom support surface 1112. The bottom support surface 1112 is connected between the front support surface 1111 and the rear support surface 1113, and the rear support surface 1113 is arranged obliquely, such that the first device may be placed obliquely for easy observation and use by a user.

In an implementation mode, the size of the front support surface 1111 in the up-down direction is less than that of the rear support surface 1113 in the up-down direction to enlarge an area exposed by the first device, such that users may observe and use the first device easily.

As shown in FIGS. 1-6, first heat-dissipation holes 112 are formed in the receiving slot 111. Circulation chambers 71 are formed in the main body 10, and the first heat-dissipation holes 112 communicate with the circulation chambers 71. Second heat-dissipation holes 113 are also formed in the main body 10, and the second heat-dissipation holes 113 communicate with the circulation chambers 71. A heat-dissipation window is arranged on a bottom surface of the first device. By means of the first heat-dissipation holes 112, the circulation chambers 71 and the second heat-dissipation holes 113 which communicate with each other, an airflow from the heat-dissipation window may sequentially pass through the first heat-dissipation holes 112, the circulation chambers 71 and the second heat-dissipation holes 113 to reach the outside, or air from the outside may sequentially pass through the second heat-dissipation holes 113, the circulation chambers 71 and the first heat-dissipation holes 112 to reach the heat-dissipation window.

In an implementation mode, the main body 10 includes a first shell 11 and a second shell 12, and the first shell 11 and the second shell 12 define a receiving space 70 jointly. The second shell 12 is provided with partitions 121 that extend towards the first shell 11, the partitions 121 partition the receiving space 70 into the circulation chambers 71 and a receiving chamber 72, and the first connector 20 and the second connector 30 are received in the receiving chamber 72. By means of the partitions 121, an airflow is prevented from entering the receiving chamber 72, and the airflow resistance is reduced, thereby guaranteeing the heat-dissipation effect of the first device.

As shown in FIGS. 1-6, the second heat-dissipation holes 113 and the second connector 30 are arranged on different surfaces, such that the second heat-dissipation holes 113 will not be blocked by the second device when the adapter 100 is connected to the second device, thereby preventing the heat-dissipation effect of the first device from being compromised.

In this embodiment, the second connector 30 is exposed out of a bottom surface of the main body 10, and the second heat-dissipation holes 113 are formed in left and right side surfaces of the main body 10.

In an implementation mode, the second connector 30 is exposed out of a rear side surface of the main body 10, and the second heat-dissipation holes 113 may be formed in left and right side surfaces of the main body 10, a top surface of the main body 10, a bottom surface of the main body 10, and a front surface of the main body 10. If the second heat-dissipation holes 113 are formed in the top surface of the main body 10, the airflow resistance will be relatively large, thus compromising the heat-dissipation effect of the first device. In an implementation mode, the second heat-dissipation holes 113 are formed in the left and right side surfaces of the main body 10, the bottom surface of the main body 10 and the front surface of the main body 10.

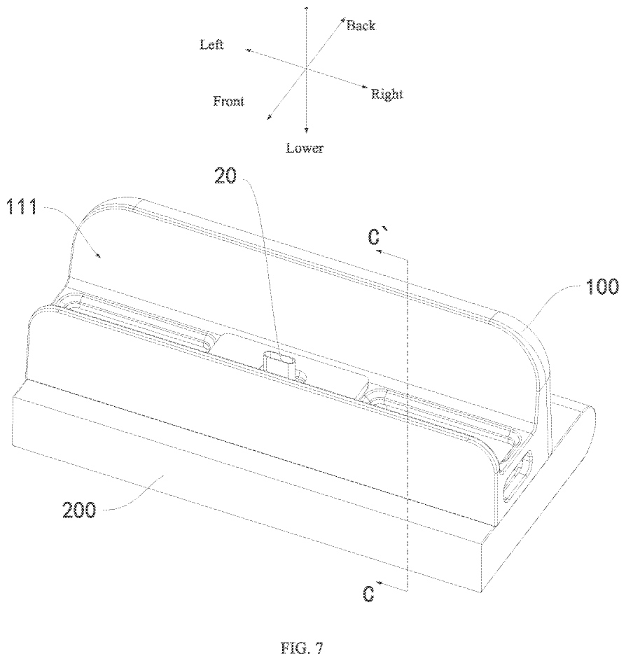

As shown in FIGS. 7-9, this embodiment further provides a charging device, including the adapter 100 and a charging base 200, where the charging base 200 is provided with an output module 210, and the second connector 30 of the adapter 100 is connected to the output module 210 to connect the adapter 100 to the charging base 200. When the first device is placed in the receiving slot 111 of the adapter 100 and is connected to the first connector 20, the charging base 200 and the first device are connected. By means of the receiving slot 111 formed in the adapter 100, the first device may be easily placed on the charging device to be used and observed by users, thereby improving the usage experience of users.

As shown in FIGS. 7-9, one of the output module 210 and the adapter 100 is provided with an assembly slot 211, the other one of the output module 210 and the adapter 100 is provided with an assembly portion 122, and the assembly portion 122 is matched with the assembly slot 211 to assemble the adapter 100 onto the output module 210, such that positioning and assembly of the adapter 100 and the output module 210 are achieved, and the connection between the second connector 30 and the output module 210 is facilitated.

In this embodiment, the second connector 30 is exposed out of the bottom surface of the main body 10, and a protruding assembly portion 122 is arranged on the bottom surface of the main body 10. An assembly slot 211 is formed in the output module 210, and the assembly portion 122 of the adapter 100 is inlaid in the assembly slot 211 of the output module 210 to assemble the adapter 100 onto the charging base 200.

In an implementation mode, an assembly slot 211 is formed in a surface, from which the second connector 30 is exposed, of the main body 10, the output module 210 is provided with an assembly portion 122, and the assembly portion 122 of the output module 210 is inlaid in the assembly slot 211 of the adapter 100 to assemble the adapter 100 onto the charging base 200.

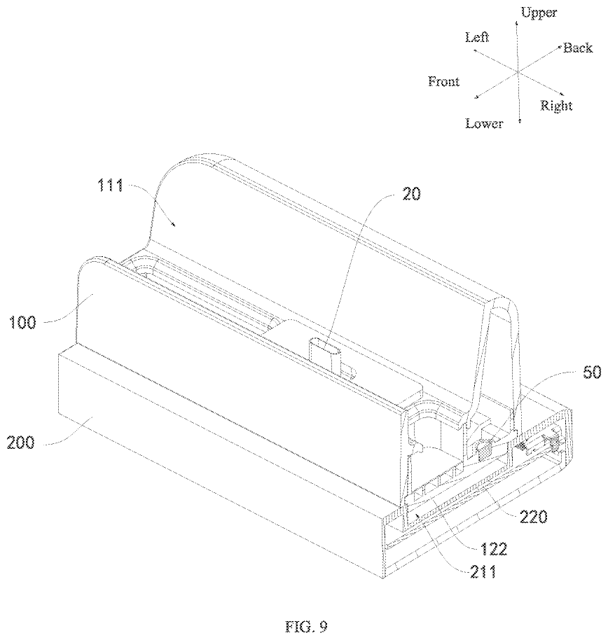

As shown in FIG. 9, one of the charging base 200 and the adapter 100 is provided with a sensor 220, and the other one of the charging base 200 and the adapter 100 is provided with a sensed part 50. The sensor 220 senses the sensed part 50 to realize control of the charging base 200 or the adapter 100 (to be specific, to realize on-off control of the charging base 200 or the adapter 100).

In this embodiment, the sensed part 50 is arranged in the adapter 100, and the sensor 220 is arranged in the charging base 200. The sensor 220 senses the sensed part 50 to control the charging base 200 to operate.

In an implementation mode, the sensor 220 is a Hall sensor, and the sensed part 50 is a magnetic part.

In another implementation mode, the sensed part 50 is arranged in the charging base 200, and the sensor 220 is arranged in the adapter 100. The sensor 220 senses the sensed part 50 to control on/off of the adapter 100.

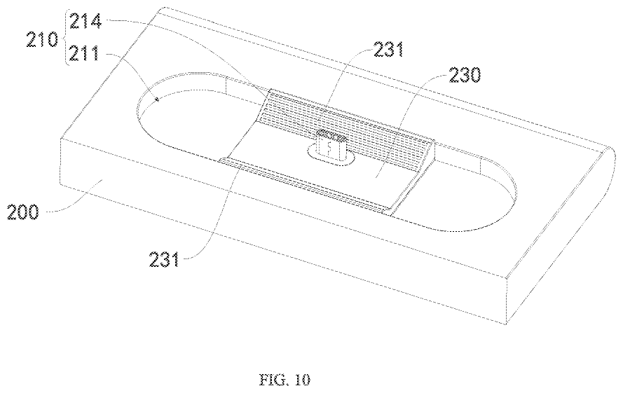

As shown in FIGS. 10 and 3, the assembly slot 211 is formed in the output module 210 and is open upward, a guide plate 230 is arranged in the middle of the assembly slot 211, an output terminal 214 of the output module 210 upward penetrates through the guide plate 230, oblique guide surfaces 231 are arranged at front and rear ends of the guide plate 230, and slopes matched with the guide surfaces 231 are arranged at positions, corresponding to the guide plate 230, of the assembly portion 122. In this way, a positioning and guiding effect may be achieved when the second connector 30 of the adapter 100 and the output terminal 214 of the output module 210 are connected, thus facilitating the connection between the second connector 30 and the output module 210.

The above embodiment is merely used for explaining the technical solution of the present disclosure rather than limiting the present disclosure. Other modifications or equivalent substitutions made by those ordinarily skilled in the art without departing from the spirit and scope of the technical solution of the present disclosure should also fall within the scope of the claims of the present disclosure.

What is claimed is:

1. An easy-to-assemble adapter, comprising a main body and a first connector, the first connector being connected to a first device, the main body being provided with a receiving slot for receiving the first device, and the first connector being rotatably arranged in the receiving slot, wherein the adapter further comprises a rotating shaft limiting member, the rotating shaft limiting member is detachably connected to the main body, the first connector is provided with a rotating shaft portion, and the main body and the rotating shaft limiting member clamp the rotating shaft portion jointly.

2. The adapter according to claim 1, wherein the rotating shaft portion extends in a length direction of the receiving slot, and a direction from the first connector to the rotating shaft limiting member is perpendicular to the length direction of the receiving slot.

3. The adapter according to claim 1, wherein the main body is provided with a rotation limiting portion, the rotation limiting portion and the rotating shaft limiting member define a shaft hole jointly, and the rotating shaft portion is inlaid in the shaft hole.

4. The adapter according to claim 1, further comprising a spacer, wherein the spacer is disposed around the first connector to fill in a gap between the first device and the receiving slot.

5. The adapter according to claim 1, wherein the receiving slot comprises a front support surface, a rear support surface and a bottom support surface, the bottom support surface is connected between the front support surface and the rear support surface, and the rear support surface is arranged obliquely to allow the first device to be placed obliquely.

6. The adapter according to claim 1, wherein first heat-dissipation holes are formed in the receiving slot, circulation chambers are formed in the main body, the first heat-dissipation holes communicate with the circulation chambers, second heat-dissipation holes are also formed in the main body, and the second heat-dissipation holes communicate with the circulation chambers.

7. The adapter according to claim 6, further comprising a second connector, wherein the second connector is connected to a second device, and the second heat-dissipation holes and the second connector are located on different surfaces.

8. The adapter according to claim 7, wherein the main body comprises a first shell and a second shell, and the first shell and the second shell define a receiving space jointly; the second shell is provided with partitions that extend towards the first shell, the partitions partition the receiving space into the circulation chambers and a receiving chamber, and the first connector and the second connector are received in the receiving chamber.

9. The adapter according to claim 1, wherein the rotating shaft portion comprises a body and rotating shafts located on two sides of the body, and a circumferential section of the body of the rotating shaft portion is sector-shaped or arc-shaped.

10. The adapter according to claim 9, wherein a chamfered surface, fitting with an outer surface of the body, is arranged at a position, corresponding to the body of the rotating shaft portion, inside the main body.

11. A charging device, comprising a charging base and the adapter according to claim 1, wherein the charging base is provided with an output module, and the adapter is connected to the output module.

12. The charging device according to claim 11, wherein one of the output module and the adapter is provided with an assembly slot, the other one of the output module and the adapter is provided with an assembly portion, and the assembly portion is matched with the assembly slot to assemble the adapter onto the output module.

13. The charging device according to claim 11, wherein one of the charging base and the adapter is provided with a sensor, and the other one of the charging base and the adapter is provided with a sensed part.

14. The charging device according to claim 12, wherein the assembly slot is formed in the output module, a guide plate is arranged in the assembly slot, an output terminal of the output module penetrates through the guide plate, an oblique guide surface is arranged on the guide plate, and a slope matched with the guide surface is correspondingly arranged on the assembly portion.
